(19) United States
(12) Patent Application Publication
(10) Pub. No.: US 2015/0261306 A1
(43) Pub. Date: Sep. 17, 2015

(54) SYSTEMS, DEVICES, AND METHODS FOR SELECTING BETWEEN MULTIPLE WIRELESS CONNECTIONS

(71) Applicant: Thalmic Labs Inc., Kitchener (CA)

(72) Inventor: Stephen Lake, Kitchener (CA)

(21) Appl. No.: 14/658,552

(22) Filed: Mar. 16, 2015

Related U.S. Application Data
(60) Provisional application No. 61/954,379, filed on Mar. 17, 2014.

(51) Int. Cl. G06F 3/01

(52) U.S. Cl. CPC G06F 3/017

(57) ABSTRACT

Systems, devices, and methods that select between multiple wireless connections are described. A gesture-based control device detects physical gestures performed by the user. The user performs a specific gesture to indicate a particular perceiving device from a set of available receiving devices with which the user desires to interact. The device identifies the gesture and determines, based on the gesture identity, the particular receiving device in the set of available receiving devices with which the user desires to interact. Based on this determination, the device establishes a wireless connection with the particular receiving device with which the user desires to interact.

### BACKGROUND

1. Technical Field

The present systems, devices, and methods generally relate to wireless communications and particularly relate to selecting between multiple available wireless connections.

2. Description of the Related Art

Portable and Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other electronic systems; however, a small and lightweight electronic device may still be considered portable even if it includes a wire-connection to another electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

### Wireless Communications

As described above, a portable electronic device may be designed to operate without any wire-connections to other electronic devices. The exclusion of external wire-connections enhances the portability of a portable electronic device. In order to interact with other electronic devices in the absence of external wire-connections, portable electronic devices (i.e., wearable or otherwise) commonly employ wireless communication techniques. A person of skill in the art will be familiar with common wireless communication protocols, such as Bluetooth®, ZigBee®, WiFi®, Near Field Communication (NFC), and the like.

There are specific challenges that arise in wireless communications that are not encountered in wire-based communications. For example, establishing a direct communicative link (i.e., a “connection”) between two electronic devices is quite straightforward in wire-based communications: connect a first end of a wire to a first device and a second end of the wire to a second device. Conversely, the same thing is much less straightforward in wireless communications. Wireless signals are typically broadcast out in the open and may impinge upon any and all electronic devices within range. In order to limit a wireless interaction to be between specific electronic devices (e.g., between a specific pair of electronic devices), the wireless signals themselves are typically configured to be receivable or usable by only the specific device(s) to which the signals are intended to be transmitted. For example, wireless signals may be encrypted and an intended receiving device may be configured to decrypt the signals, and/or wireless signals may be appended with “device ID” information that causes only the device bearing the matching “device ID” to respond to the wireless signal.

Wireless connections are advantageous in portable electronic devices because wireless connections enable a portable electronic device to interact with a wide variety of other devices without being encumbered by wire connections and without having to physically connect/disconnect to/from any of the other devices. However, the complicated signal configurations that are necessary to effect one-to-one (one:one) wireless communication between specific devices can make it difficult to swap wireless connections. Significant signal restructuring is typically necessary in order to break a first wireless connection between a first device and a second device and to establish a second wireless connection between the first device and a third device. Typically, the process of wirelessly disconnecting from a first device and establishing a new wireless connection with a second device is initiated manually by the user (by, for example, pushing and often holding down a button) and is unduly extensive. Usually, after the first wireless connection is broken, the transmitting device enters into a “connection establishment mode” in which it scans for available wireless connections and the user must manually select which available wireless connection is desired. The advantage of communicative versatility afforded by wireless connections is diminished by the extended user intervention and processing effort that is often required to swap between connections. There remains a need in the art for systems, devices, and methods that rapidly and reliably select between multiple wireless connections.

### Human-Electronics Interfaces

A portable electronic device may provide direct functionality for a user (such as audio playback, data display, computing functions, etc.) or it may provide electronics to interact with, receive information from, or control another electronic device. For example, a wearable electronic device may include sensors that detect inputs from a user and transmit signals to another electronic device based on those inputs. Sensor-types and input-types may each take on a variety of forms, including but not limited to: tactile sensors (e.g., buttons, switches, touchpads, or keys) providing manual control, acoustic sensors providing voice-control, electromyography sensors providing gesture control, and/or accelerometers providing gesture control.

A human-computer interface (“HCl”) is an example of a human-electronics interface. The present systems, devices, and methods may be applied to HCIs, but may also be applied to any other form of human-electronics interface.

### Electromyography Devices

Electromyography (“EMG”) is a process for detecting and processing the electrical signals generated by muscle activity. EMG devices employ EMG sensors that are responsive to the range of electrical potentials (typically μV-mV) involved in muscle activity. EMG signals may be used in a wide variety of applications, including: medical monitoring and diagnosis, muscle rehabilitation, exercise and training, prosthetic control, and even in controlling functions of electronic devices.

### BRIEF SUMMARY

A method of operating a gesture-based control device to establish a wireless connection between the gesture-based control device and a particular receiving device, wherein the gesture-based control device includes a processor, at least one sensor communicatively coupled to the processor, and a wireless transmitter communicatively coupled to the processor, may be summarized as including: detecting a first gesture performed by a user of the gesture-based control device by the at least one sensor, the first gesture indicative of a first receiving device with which the user desires to interact; identifying, by the processor, the first gesture performed by the user; determining, by the processor, the first receiving device with which the user desires to interact based on the identified first gesture; configuring, by the processor, a first signal for use exclusively by the first receiving device; and wirelessly transmitting the first signal to the first receiving device by the wireless transmitter.

The at least one sensor may include at least one electromyography (“EMG”) sensor, and detecting a first gesture performed by a user of the gesture-based control device by the at least one sensor may include detecting muscle activity of the user by the at least one EMG sensor in response to the user performing the first gesture.

The at least one sensor may include at least one inertial sensor, and detecting a first gesture performed by a user of the gesture-based control device by the at least one sensor may include detecting motion of the user by the at least one inertial sensor in response to the user performing the first gesture.

The gesture-based control device may further include a non-transitory processor-readable storage medium communicatively coupled to the processor, wherein the non-transitory processor-readable storage medium stores processor-executable gesture identification instructions, and identifying, by the processor, the first gesture performed by the user may include executing, by the processor, the gesture identification instructions to cause the processor to identify the first gesture performed by the user. The non-transitory processor-readable storage medium may further store processor-executable wireless connection instructions, and determining, by the processor, the first receiving device with which the user desires to interact based on the identified first gesture may include executing, by the processor, the wireless connection instructions to cause the processor to determine the first receiving device with which the user desires to interact based on the identified first gesture. Configuring, by the processor, a first signal for use exclusively by the first receiving device may include executing, by the processor, the wireless connection instructions to cause the processor to configure the first signal for use exclusively by the first receiving device.

Configuring, by the processor, a first signal for use exclusively by the first receiving device may include encrypting the first signal by the processor.

Configuring, by the processor, a first signal for use exclusively by the first receiving device may include programming, by the processor, the first signal with device identification data that is unique to the first receiving device.

The gesture-based control device may further include a non-transitory processor-readable storage medium communicatively coupled to the processor, with the method further including: sequentially pairing the gesture-based control device with each receiving device in a set of receiving devices; and storing, in the non-transitory processor-readable storage medium, respective pairing information corresponding to each respective receiving device in the set of receiving devices. Determining, by the processor, the first receiving device with which the user desires to interact based on the identified first gesture may include determining, by the processor, which receiving device in the set of receiving devices corresponds to the first receiving device with which the user desires to interact based on the identified first gesture. Configuring, by the processor, a first signal for use exclusively by the first receiving device may include configuring, by the processor, the first signal based on the pairing information corresponding to the first receiving device that is stored in the non-transitory processor-readable storage medium.

The method may further include: detecting a second gesture performed by a user of the gesture-based control device by the at least one sensor, the second gesture indicative of a second receiving device with which the user desires to interact; identifying, by the processor, the second gesture performed by the user; determining, by the processor, the second receiving device with which the user desires to interact based on the identified second gesture; configuring, by the processor, a second signal for use exclusively by the second receiving device; and wirelessly transmitting the second signal to the second receiving device by the wireless transmitter.

A gesture-based control device may be summarized as including: at least one sensor responsive to gestures performed by a user of the gesture-based control device, wherein in response to gestures performed by the user the at least one sensor provides detection signals; a processor communicatively coupled to the at least one sensor; a non-transitory processor-readable storage medium communicatively coupled to the processor, wherein the non-transitory processor-readable storage medium stores: processor-executable gesture identification instructions that, when executed by the processor, cause the processor to identify a first gesture performed by the user based on at least a first detection signal provided by the at least one sensor in response to the user performing the first gesture; and processor-executable wireless connection instructions that, when executed by the processor, cause the processor to: determine a first receiving device with which the user desires to interact based on the identified first gesture; and configure a first communication signal for use exclusively by the first receiving device; and a wireless transmitter communicatively coupled to the processor to wirelessly transmit communication signals. The at least one sensor may include at least one sensor selected from the group consisting of: electromyography (“EMG”) sensor, an inertial sensor, a mechanomyography sensor, a bioacoustics sensor, a camera, an optical sensor, and an infrared light sensor.

The gesture-based control device may further include a band that in use is worn on an arm of the user, wherein the at least one sensor, the processor, the non-transitory processor-readable storage medium, and the wireless transmitter are all carried by the band. The processor-executable gesture identification instructions, when executed by the processor, may further cause the processor to identify a second gesture performed by the user based on at least a second detection signal provided by the at least one sensor in response to the user performing the second gesture. The processor-executable wireless connection instructions, when executed by the processor, may further cause the processor to: determine a second receiving device with which the user desires to interact based on the identified second gesture; and configure a second communication signal for use exclusively by the second receiving device.

The non-transitory processor-readable storage medium may further include a capacity to store respective pairing information corresponding to each respective receiving device in a set of receiving devices.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a perspective view of an exemplary gesture-based control device that enables a user to use physical gestures to select between multiple potential wireless connections in accordance with the present systems, devices, and methods.

FIG. 2 is a flow-diagram showing a method of establishing a wireless connection between a gesture-based control device and a particular receiving device in accordance with the present systems, devices, and methods.

FIG. 3 is an illustrative diagram of wireless communication between a gesture-based control device and a particular receiving device in a set of available receiving devices in accordance with the present systems, devices, and methods.

FIG. 4 is an illustrative diagram of a non-transitory processor-readable storage medium carried on-board a gesture-based control device and including both processor-executable gesture identification instructions and processor-executable wireless connection instructions in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic devices, and in particular portable electronic devices such as wearable electronic devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

Portable electronic devices are ubiquitous throughout the world today, and the portability of such devices is significantly enhanced by the ability to communicate with other devices via wireless connections. The various embodiments described herein provide systems, devices, and methods for rapidly and reliably selecting between multiple available wireless connections.

Throughout this specification and the appended claims, the term “wireless connection” is used to refer to a direct communicative link between at least two electronic devices that employs one or more wireless communication protocol(s), such as Bluetooth®, ZigBee®, WiFi®, Near Field Communication (NFC), or similar. In the art, a wireless connection is typically established by communicatively linking two devices after an a initial configuration process called “pairing.”

The various embodiments described herein provide systems, devices, and methods that enable a user to select between multiple wireless connections by performing simple physical gestures. A “gesture-based control device” may wirelessly connect to any particular receiving device in response to one or more deliberate gesture(s) performed by the user. Thereafter, the user may control, communicate with, or otherwise interact with the particular receiving device via the gesture-based control device, and/or via another control means that is in communication with the gesture-based control device.

A detailed description of an exemplary gesture-based control device in accordance with the present systems, devices, and methods is now provided. However, the exemplary gesture-based control device described below is provided for illustrative purposes only and a person of skill in the art will appreciate that the teachings herein may be applied with or otherwise incorporated into other forms of gesture-based control devices, or more generally, other electronic devices that sense or detect gestures performed by a user (including, for example, camera-based gesture detection devices).

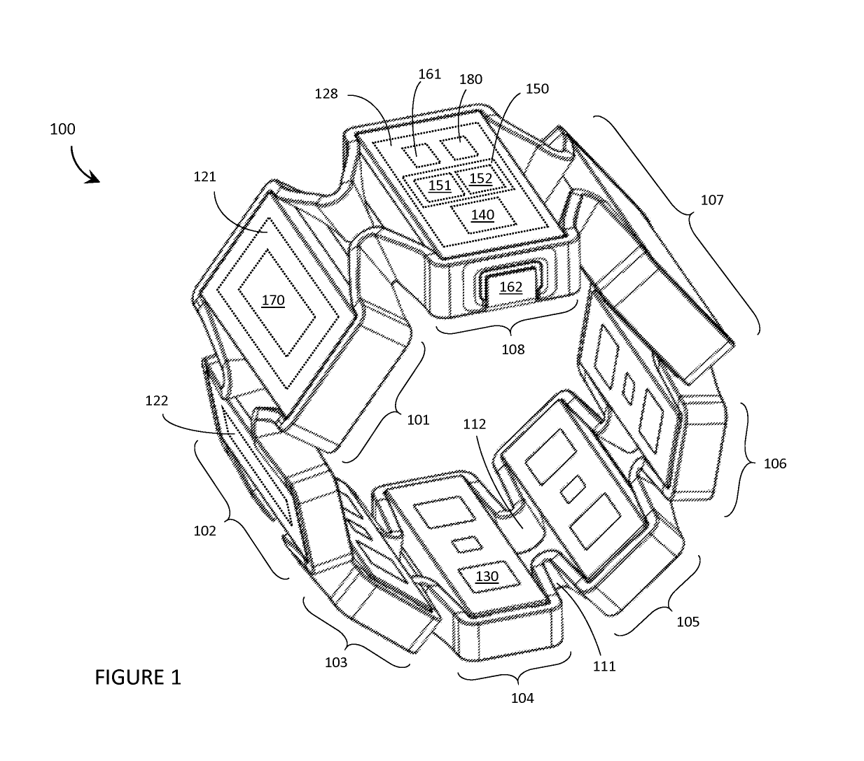

FIG. 1 is a perspective view of an exemplary gesture-based control device 100 that enables a user to use physical gestures to select between multiple potential wireless connections in accordance with the present systems, devices, and methods. Exemplary gesture-based control device 100 may, for example, form part of a human-electronics interface. Exemplary gesture-based control device 100 is an armband designed to be worn on the forearm of a user, though a person of skill in the art will appreciate that the teachings described herein may readily be applied in gesture-based control devices designed to be worn elsewhere on the body of the user, including without limitation: on the upper arm, wrist, hand, finger, leg, foot, torso, or neck of the user, and/or in gesture-based control devices that are designed to be separate from (i.e., not worn by) the user (such as camera-based control devices).

Gesture-based control device 100 is a wearable electronic device. Device 100 includes a set of eight pod structures 101, 102, 103, 104, 105, 106, 107, and 108 that form physically coupled links thereof. Each pod structure in the set of eight pod structures 101, 102, 103, 104, 105, 106, 107, and 108 is positioned adjacent at least one other pod structure in the set of pod structures at least approximately on a perimeter of gesture-based control device 100. More specifically, each pod structure in the set of eight pod structures 101, 102, 103, 104, 105, 106, 107, and 108 is positioned adjacent and in between two other pod structures in the set of eight pod structures such that the set of pod structures forms a circumference or perimeter of an annular or closed loop (e.g., closed surface) configuration. For example, pod structure 101 is positioned adjacent and in between pod structures 102 and 108 at least approximately on a circumference or perimeter of the annular or closed loop configuration of pod structures, pod structure 102 is positioned adjacent and in between pod structures 101 and 103 at least approximately on the circumference or perimeter of the annular or closed loop configuration, pod structure 103 is positioned adjacent and in between pod structures 102 and 104 at least approximately on the circumference or perimeter of the annular or closed loop configuration, and so on. Each of pod structures 101, 102, 103, 104, 105, 106, 107, and 108 is both electrically conductively coupled and adaptively physically coupled to, over, or through the two adjacent pod structures by at least one adaptive coupler 111, 112. For example, pod structure 101 is adaptively physically coupled to both pod structure 108 and pod structure 102 by adaptive couplers 111 and 112. Further details of exemplary adaptive physical coupling mechanisms that may be employed in gesture-based control device 100 are described in, for example: U.S. Provisional Patent Application Ser. No. 61/857,105 (now US Patent Publication US 2015-0025355 A1); U.S. Provisional Patent Application Ser. No. 61/860,063) and U.S. Provisional Patent Application Ser. No. 61/822,740 (now combined in US Patent Publication US 2014-0334083 A1); and U.S. Provisional Patent Application Ser. No. 61/940,048 (now U.S. Non-Provisional patent application Ser. No. 14/621,044), each of which is incorporated by reference herein in its entirety. Device 100 is depicted in FIG. 1 with two adaptive couplers 111, 112, each positioned at least approximately on the circumference of gesture-based control device 100 and each providing both serial electrically conductive coupling and serial adaptive physical coupling over, through, or between all of the pod structures in the set of eight pod structures 101, 102, 103, 104, 105, 106, 107, and 108.

Throughout this specification and the appended claims, the term “pod structure” is used to refer to an individual link, segment, pod, section, structure, component, etc. of a wearable electronic device. For the purposes of the present systems, devices, and methods, an “individual link, segment, pod, section, structure, component, etc.” (i.e., a “pod structure”) of a wearable electronic device is characterized by its ability to be moved or displaced relative to another link, segment, pod, section, structure component, etc. of the wearable electronic device. For example, pod structures 101 and 102 of device 100 can each be moved or displaced relative to one another within the constraints imposed by the adaptive couplers 111, 112 providing adaptive physical coupling therebetween. The desire for pod structures 101 and 102 to be movable/displaceable relative to one another specifically arises because device 100 is a wearable electronic device that advantageously accommodates the movements of a user and/or different user forms.

Device 100 includes eight pod structures 101, 102, 103, 104, 105, 106, 107, and 108 that form physically coupled links thereof. The number of pod structures included in a wearable electronic device is dependent on at least the nature, function(s), and design of the wearable electronic device, and the present systems, devices, and methods may be applied to any wearable electronic device employing any number of pod structures, including wearable electronic devices employing more than eight pod structures and wearable electronic devices employing fewer than eight pod structures (e.g., at least two pod structures, such as three or more pod structures).

Wearable electronic devices employing pod structures (e.g., device 100) are used herein as exemplary gesture-based control device designs, while the present systems, devices, and methods may be applied to gesture-based control devices that do not employ pod structures (or that employ any number of pod structures). Thus, throughout this specification, descriptions relating to pod structures (e.g., functions and/or components of pod structures) should be interpreted as being generally applicable to functionally-similar configurations in any gesture-based control device design, even gesture-based control device designs that do not employ pod structures (except in cases where a pod structure is specifically recited in a claim). As discussed, previously, the present systems, devices, and methods may also be applied to or employed by gesture-based control devices that are not wearable.

In exemplary device 100 of FIG. 1, each of pod structures 101, 102, 103, 104, 105, 106, 107, and 108 comprises a respective housing having a respective inner volume. Each housing may be formed of substantially rigid material and may be optically opaque. Throughout this specification and the appended claims, the term “rigid” as in, for example, “substantially rigid material,” is used to describe a material that has an inherent resiliency, i.e., a tendency to maintain or restore its shape and resist malformation/deformation under the moderate stresses and strains typically encountered by a wearable electronic device.

Details of the components contained within the housings (i.e., within the inner volumes of the housings) of pod structures 101, 102, 103, 104, 105, 106, 107, and 108 are not visible in FIG. 1. To facilitate descriptions of exemplary device 100, some internal components are depicted by dashed lines in FIG. 1 to indicate that these components are contained in the inner volume(s) of housings and may not normally be actually visible in the view depicted in FIG. 1, unless a transparent or translucent material is employed to form the housings. For example, any or all of pod structures 101, 102, 103, 104, 105, 106, 107, and/or 108 may include circuitry (i.e., electrical and/or electronic circuitry). In FIG. 1, a first pod structure 101 is shown containing circuitry 121 (i.e., circuitry 121 is contained in the inner volume of the housing of pod structure 101), a second pod structure 102 is shown containing circuitry 122, and a third pod structure 108 is shown containing circuitry 128. The circuitry in any or all pod structures may be communicatively coupled to the circuitry in at least one adjacent pod structure by at least one respective internal wire-based connection. Communicative coupling between circuitries of pod structures in device 100 may advantageously include systems, devices, and methods for stretchable printed circuit boards as described in U.S. Provisional Patent Application Ser. No. 61/872,569 (now US Patent Publication US 2015-0065840 A1) and/or systems, devices, and methods for signal routing as described in U.S. Provisional Patent Application Ser. No. 61/866,960 (now US Patent Publication US 2015-0051470 A1), both of which are incorporated by reference herein in their entirety.

Each individual pod structure within a wearable electronic device may perform a particular function, or particular functions. For example, in device 100, each of pod structures 101, 102, 103, 104, 105, 106, and 107 includes a respective sensor 130 (only one called out in FIG. 1 to reduce clutter) responsive to (i.e. to detect) signals when a user performs a physical gesture and to provide electrical signals in response to detecting such signals. Thus, each of pod structures 101, 102, 103, 104, 105, 106, and 107 may be referred to as a respective “sensor pod.” Throughout this specification and the appended claims, the term “sensor pod” is used to denote an individual pod structure that includes at least one sensor responsive to (i.e., to detect or sense) signals from a user. Each of sensors 130 may be any type of sensor that is capable of detecting a signal produced, generated, or otherwise effected by the user, including but not limited to: an electromyography sensor, a magnetomyography sensor, a mechanomyography sensor a blood pressure sensor, a heart rate sensor, an inertial sensor (e.g., a gyroscope or an accelerometer), a compass, and/or a thermometer. In exemplary device 100, each of sensors 130 includes a respective electromyography (“EMG”) sensor responsive to (i.e., to detect) signals from the user in the form of electrical signals produced by muscle activity when the user performs a physical gesture. Gesture-based control device 100 may transmit information based on the detected signals to one or more receiving device(s) as part of a human-electronics interface (e.g., a human-computer interface). Further details of exemplary electromyography device 100 are described in at least U.S. patent application Ser. No. 14/186,878, U.S. patent application Ser. No. 14/186,889, U.S. patent application Ser. No. 14/194,252, U.S. Provisional Patent Application Ser. No. 61/869,526 (now US Patent Publication US 2015-0057770 A1), and U.S. Provisional Patent Application Ser. No. 61/909,786 (now U.S. Non-Provisional patent application Ser. No. 14/553,657), each of which is incorporated herein by reference in its entirety. Those of skill in the art will appreciate, however, that a gesture-based control device having electromyography functionality is used only as an example in the present systems, devices, and methods and that the systems, devices and methods for gesture-based control devices that employ other means of gesture detection may similarly implement or incorporate the teachings herein.

Pod structure 108 of device 100 includes a processor 140 that processes the “detection signals” provided by the EMG sensors 130 of sensor pods 101, 102, 103, 104, 105, 106, and 107 in response to detected muscle activity. Pod structure 108 may therefore be referred to as a “processor pod.” Throughout this specification and the appended claims, the term “processor pod” is used to denote an individual pod structure that includes at least one processor to process signals. The processor may be any type of processor, including but not limited to: a digital microprocessor or microcontroller, an application-specific integrated circuit (ASIC), a field-programmable gate array (FPGA), a digital signal processor (DSP), a graphics processing unit (GPU), a programmable gate array (PGA), a programmable logic unit (PLU), or the like, that analyzes or otherwise processes the signals to determine at least one output, action, or function based on the signals. Implementations that employ a digital processor (e.g., a digital microprocessor or microcontroller, a DSP) may advantageously include a non-transitory processor-readable storage medium or memory 150 communicatively coupled thereto and storing processor-executable instructions that control the operations thereof, whereas implementations that employ an ASIC, FPGA, or analog processor may or may not include a non-transitory processor-readable storage medium 150.

As used throughout this specification and the appended claims, the terms “sensor pod” and “processor pod” are not necessarily exclusive. A single pod structure may satisfy the definitions of both a “sensor pod” and a “processor pod” and may be referred to as either type of pod structure. For greater clarity, the term “sensor pod” is used to refer to any pod structure that includes a sensor and performs at least the function(s) of a sensor pod, and the term processor pod is used to refer to any pod structure that includes a processor and performs at least the function(s) of a processor pod. In device 100, processor pod 108 includes an EMG sensor 130 (not visible in FIG. 1) responsive to (i.e., to sense, measure, transduce or otherwise detect) muscle activity of a user, so processor pod 108 could be referred to as a sensor pod. However, in exemplary device 100, processor pod 108 is the only pod structure that includes a processor 140, thus processor pod 108 is the only pod structure in exemplary device 100 that can be referred to as a processor pod. The processor 140 in processor pod 108 also processes the EMG signals provided by the EMG sensor 130 of processor pod 108. In alternative embodiments of device 100, multiple pod structures may include processors, and thus multiple pod structures may serve as processor pods. Similarly, some pod structures may not include sensors, and/or some sensors and/or processors may be laid out in other configurations that do not involve pod structures.

In device 100, processor 140 includes and/or is communicatively coupled to a non-transitory processor-readable storage medium or memory 150. As described in more detail later on, memory 150 may store processor-executable: i) gesture identification instructions 151 that, when executed by processor 140, cause processor 140 to process the EMG “detection signals” from EMG sensors 130 and identify a gesture to which the EMG signals correspond; and ii) wireless connection instructions 152 that, when executed by processor 140, cause processor 140 to determine a particular receiving device with which the user desires to interact based on the identified gesture. For communicating with a separate electronic device (not shown), wearable electronic device 100 includes at least one communication terminal. Throughout this specification and the appended claims, the term “communication terminal” is generally used to refer to any physical structure that provides a telecommunications link through which a data signal may enter and/or leave a device. A communication terminal represents the end (or “terminus”) of communicative signal transfer within a device and the beginning of communicative signal transfer to/from an external device (or external devices). As examples, device 100 includes a first communication terminal 161 and a second communication terminal 162. First communication terminal 161 includes a wireless transmitter, wireless receiver, wireless transceiver or radio (i.e., a wireless communication terminal) and second communication terminal 162 includes a tethered connector port 162. Wireless transmitter 161 may include, for example, a Bluetooth® transmitter (or similar) or radio and connector port 162 may include a Universal Serial Bus port, a mini-Universal Serial Bus port, a micro-Universal Serial Bus port, a SMA port, a THUNDERBOLT® port, or the like. Either in addition to or instead of serving as a communication terminal, connector port 162 may provide an electrical terminal for charging one or more batteries 170 in device 100.

For some applications, device 100 may also include at least one inertial sensor 180 (e.g., an inertial measurement unit, or “IMU,” that includes at least one accelerometer and/or at least one gyroscope) responsive to (i.e., to detect, sense, or measure) motion effected by a user and provide detection signals in response to the motion. Detection signals provided by inertial sensor 180 may be combined or otherwise processed in conjunction with detection signals provided by EMG sensors 130.

Throughout this specification and the appended claims, the term “provide” and variants such as “provided” and “providing” are frequently used in the context of signals. For example, an EMG sensor is described as “providing at least one signal” and an inertial sensor is described as “providing at least one signal.” Unless the specific context requires otherwise, the term “provide” is used in a most general sense to cover any form of providing a signal, including but not limited to: relaying a signal, outputting a signal, generating a signal, routing a signal, creating a signal, transducing a signal, and so on. For example, a surface EMG sensor may include at least one electrode that resistively or capacitively couples to electrical signals from muscle activity. This coupling induces a change in a charge or electrical potential of the at least one electrode which is then relayed through the sensor circuitry and output, or “provided,” by the sensor. Thus, the surface EMG sensor may “provide” an electrical signal by relaying an electrical signal from a muscle (or muscles) to an output (or outputs). In contrast, an inertial sensor may include components (e.g., piezoelectric, piezoresistive, capacitive, etc.) that are used to convert physical motion into electrical signals. The inertial sensor may “provide” an electrical signal by detecting motion and generating an electrical signal in response to the motion.

As previously described, each of pod structures 101, 102, 103, 104, 105, 106, 107, and 108 may include circuitry (i.e., electrical and/or electronic circuitry). FIG. 1 depicts circuitry 121 inside the inner volume of sensor pod 101, circuitry 122 inside the inner volume of sensor pod 102, and circuitry 128 inside the inner volume of processor pod 118. The circuitry in any or all of pod structures 101, 102, 103, 104, 105, 106, 107 and 108 (including circuitries 111, 112, and 118) may include any or all of: an amplification circuit to amplify electrical detection signals provided by at least one EMG sensor 130, a filtering circuit to remove unwanted signal frequencies from the detection signals provided by at least one EMG sensor 130, and/or an analog-to-digital conversion circuit to convert analog detection signals into digital signals.

Detection signals that are provided by EMG sensors 130 in device 100 are routed to processor pod 108 for processing by processor 140. To this end, device 100 employs a set of wire-based communicative pathways (within adaptive couplers 111 and 112; not visible in FIG. 1) to route the signals that are output by sensor pods 101, 102, 103, 104, 105, 106, and 107 to processor pod 108. Each respective pod structure 101, 102, 103, 104, 105, 106, 107, and 108 in device 100 is communicatively coupled to, over, or through at least one of the two other pod structures between which the respective pod structure is positioned by at least one respective wire-based communicative pathway.

The use of “adaptive couplers” is an example of an implementation of an armband in accordance with the present systems, devices, and methods. More generally, device 100 comprises a band that in use is worn on an arm of the user, where the at least one sensor 130, the processor 140, the non-transitory processor-readable storage medium 150, and the wireless transmitter 161 are all carried by the band.

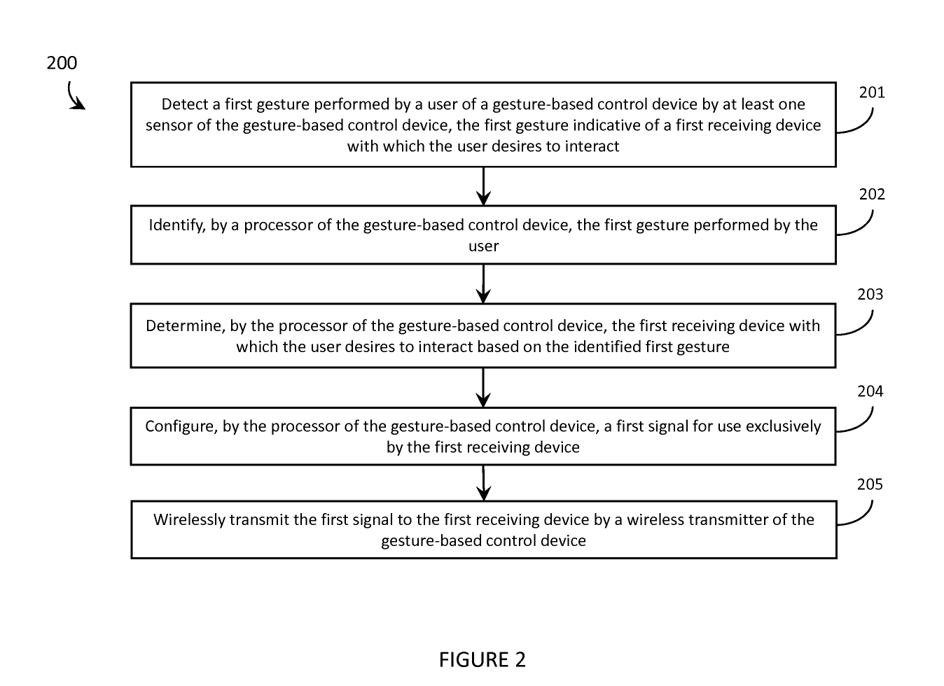

Wearable electronic device 100 is an illustrative example of a gesture-based control device that enables rapid and reliable selection between multiple wireless connections in accordance with the present systems, devices, and methods. To this end, device 100 is configured, adapted, or otherwise operable to carry out the method illustrated in FIG. 2.

FIG. 2 is a flow-diagram showing a method 200 of operating a gesture-based control device to establish a wireless connection between the gesture-based control device and a particular receiving device in accordance with the present systems, devices, and methods. The gesture-based control device includes a processor, at least one sensor communicatively coupled to the processor, and a wireless transmitter communicatively coupled to the processor as illustrated in the example of device 100 from FIG. 1. Method 200 includes five acts 201, 202, 203, 204, and 205, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments. To exemplify the relationship between the acts of method 200 and the elements of exemplary gesture-based control device 100, reference to elements of device 100 from FIG. 1 are included in parentheses throughout the description of method 200. However, a person of skill in the art will appreciate that method 200 may similarly be implemented using a different gesture-based control device.

At 201, at least one sensor (130 and/or 180) of the gesture-based control device (100) detects a first gesture performed by a user of the gesture-based control device (100). The first gesture may be indicative of a first receiving device with which the user desires to interact, e.g., via the gesture-based control device (100) and/or via another control means in communication with the gesture-based control device (100). The at least one sensor may include at least one EMG sensor (130), in which case detecting the first gesture per act 201 may include detecting muscle activity of the user by the at least one EMG sensor (130) in response to the user performing the first gesture. Either as an alternative to, or in addition to, at least one EMG sensor (130), the at least one sensor may include at least one inertial sensor (180), such as an inertial measurement unit, an accelerometer, and/or a gyroscope, in which case detecting the first gesture per act 201 may include detecting motion of the user by the at least one inertial sensor (180) in response to the user performing the first gesture.

In response to the at least one sensor (130 and/or 180) detecting the first gesture performed by the user, the at least one sensor (130 and/or 180) may provide at least a first detection signal to the processor (140) of the device (100) through the communicative coupling thereto.

At 202, the processor (140) of the gesture-based control device (100) identifies the first gesture performed by the user based, for example, on the at least a first detection signal provided by the at least one sensor (130 and/or 180). As described previously, the gesture-based control device (100) may include a non-transitory processor-readable storage medium or memory (150) communicatively coupled to the processor (140), where the non-transitory processor-readable storage medium (150) stores processor-executable gesture identification instructions (151) that, when executed by the processor (140), cause the processor (140) to identify the first gesture performed by the user per act 202. The processor-executable gesture identification instructions (151) that, when executed by the processor (140), cause the processor (140) to identify the first gesture performed by the user may include a stored mapping between sensor signals (i.e., detection signals provided by the at least one sensor 130 and/or 180) and gesture identifications (e.g., in the form of a look-up table) or may include algorithmic instructions that effect one or more mapping(s) between sensor signals and gesture identifications. As examples, the processor-executable gesture identification instructions (151) may, when executed by the processor (140), cause the processor (140) to implement one or more of the gesture recognition techniques described in U.S. Provisional Patent Application Ser. No. 61/881,064 (now U.S. Non-Provisional patent application Ser. No. 14/494,274); U.S. Provisional Patent Application Ser. No. 61/894,263 (now U.S. Non-Provisional patent application Ser. No. 14/520,081); and/or U.S. Provisional Patent Application Ser. No. 61/915,338 (now U.S. Non-Provisional patent application Ser. No. 14/567,826); each of which is incorporated by reference herein in its entirety.

At 203, the processor (14) determines the first receiving device with which the user desires to interact based on the first gesture identified at 202.

At 204, the processor (140) configures a first signal (e.g., a first “communication signal”) for use exclusively by the first receiving device. As described previously, the gesture-based control device (100) may include a non-transitory processor-readable storage medium or memory (150) communicatively coupled to the processor (140), where the non-transitory processor-readable storage medium (150) stores processor-executable wireless connection instructions (152) that, when executed by the processor (140), cause the processor (140) to: i) determine the first receiving device with which the user desires to interact based on the identified first gesture per act 203; and ii) configure a first signal (i.e., a first “communication signal”) for use exclusively by the first receiving device per act 204.

At 205, the first signal is wirelessly transmitted to the first receiving device by the wireless transmitter (161) of the gesture-based control device (100).

Configuring, by the processor (140) a first signal for use exclusively by the first receiving device per act 204 may include, for example, encrypting the first signal by the processor (140), where the first receiving device is configured to decrypt the first signal using, for example, an encryption key that is shared by both the gesture-based control device (100) and the first receiving device. Either instead of or in addition to encrypting the first signal, configuring the first signal for use exclusively by the first receiving device may include programming, by the processor (140), the first signal with device identification data that is unique to the first receiving device. For example, the first receiving device may have an identifier (such as an address or a name, e.g., a media access control or “MAC” address) that is publicly visible (by other wireless communication devices, including by the gesture-based control device (100)) and programming the first signal with device identification data that is unique to the first receiving device may include appending the identifier to the first signal in order to indicate (to all wireless communication devices in range) that the first signal is “intended for” the first receiving device.

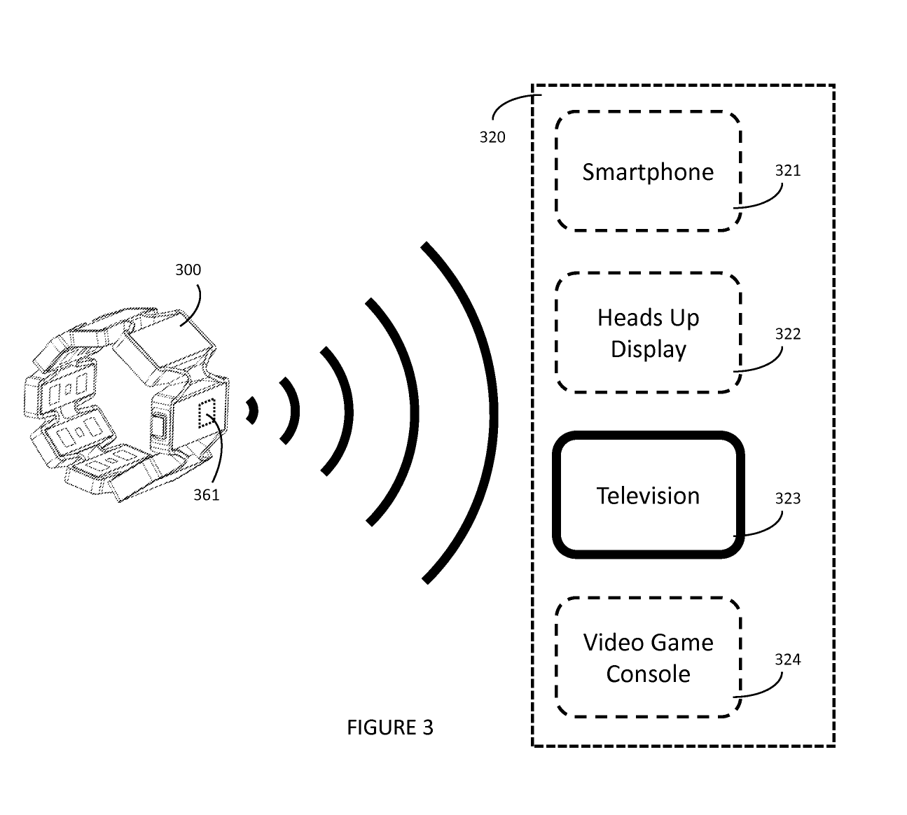

The various embodiments described herein may or may not include actually “pairing” or “bonding” the gesture-based control device with the first receiving device. For example, encrypting the first signal and/or programming the first signal with device identification data may both be implemented with or without actually “pairing” or “bonding” the gesture-based control device and the first receiving device. Accordingly, in some applications method 200 may further include (advantageously before act 201): i) sequentially pairing the gesture-based control device (100) with each receiving device in a set of receiving devices, and ii) storing, in a non-transitory processor-readable storage medium (150) of gesture-based control device (100), respective pairing information corresponding to each respective receiving device in the set of receiving devices. In such applications, determining the first receiving device with which the user desires to interact based on the identified first gesture per act 203 may include determining, based on the identified first gesture, which receiving device in the set of receiving devices corresponds to the first receiving device with which the user desires to interact. Then, configuring the first signal for use exclusively by the first receiving device per act 204 may include configuring the first signal based on the pairing information corresponding to the first receiving device that is stored in the non-transitory processor-readable storage medium (150). An example of this scenario is illustrated in FIG. 3.

FIG. 3 is an illustrative diagram of wireless communication between a gesture-based control device 300 and a particular receiving device in a set of available receiving devices 320 in accordance with the present systems, devices, and methods. Set of receiving devices 320 includes an arbitrary set of exemplary receiving devices that are each individually capable of wireless communications: a smartphone 321, a heads-up display 322, a television 323 (e.g., a smart television), and a video game console 324, though a person of skill in the art will appreciate that set of receiving devices 320 may include any number of receiving devices (within the constraints of the wireless communication protocol being used) of any form capable of wireless communications. Gesture-based control device 300 is substantially similar to device 100 from FIG. 1 and includes a wireless transmitter 361. Using, for example, a known wireless communication protocol such as Bluetooth®, gesture-based control device 300 may be paired (e.g., in sequence) with each individual receiving device 321, 322, 323, and 324 in set of receiving devices 320. As part of this pairing process, device 300 may store (in, for example, a non-transitory processor-readable storage medium on-board device 300) respective pairing information for each of receiving devices 321, 322, 323, and 324. Each of receiving devices 321, 322, 323, and 324 in set of receiving device 320 is within receiving range of wireless signals transmitted by wireless transmitter 361 of device 300 (represented by the thick curved lines in FIG. 3). In order to selectively establish a wireless connection with a particular receiving device in set of receiving devices 320, device 300 may implement method 200 from FIG. 2. For example, device 300 in use detects a first gesture performed by a user (act 201), identifies the first gesture (act 202), determines a first receiving device with which the user desires to interact (act 203) based on the identified first gesture, configures a first signal for use exclusively by the first receiving device (act 204, e.g., by programming the first signal with one or more aspect(s) based on the pairing information corresponding to the first receiving device that is stored in the non-transitory processor-readable storage medium), and wirelessly transmits the first signal to the first receiving device (act 205). In the illustration of FIG. 3, the television 323 is drawn with thick dark lines that match those of the wireless signals while the other receiving devices 321, 322, and 324 are drawn with fainter dashed lines in order to represent that television 323 is selected by the user as the “first receiving device” with which the user desires to interact.

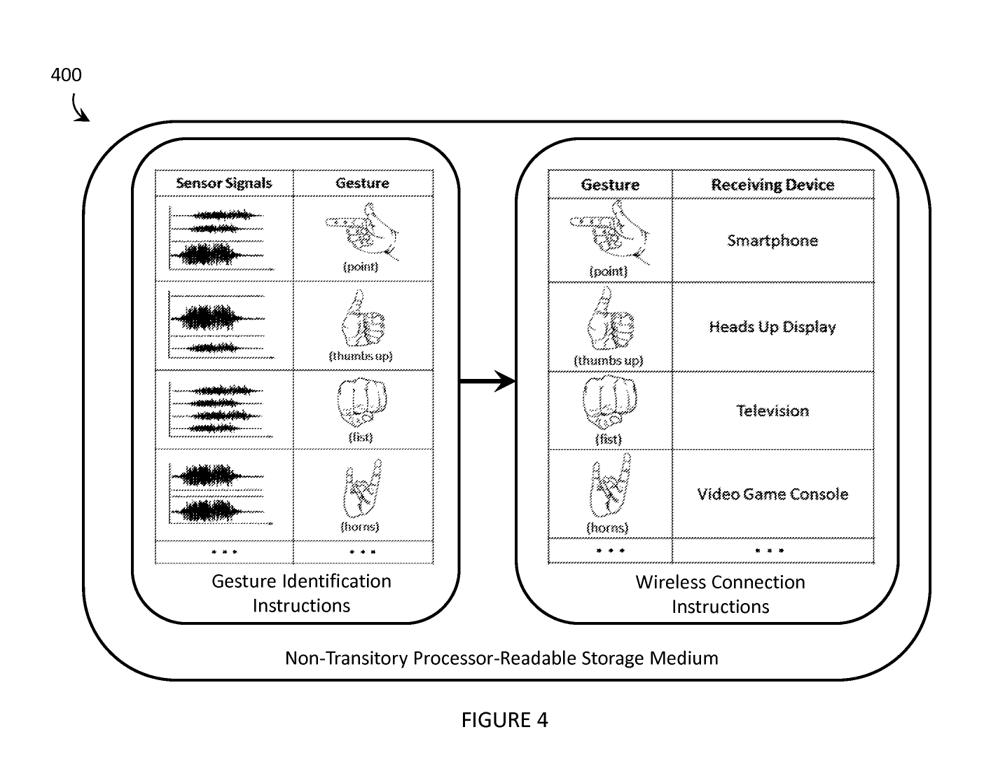

In accordance with the present systems, devices, and methods, method 200 may be extended to include additional successive wireless connections selectively established by the user of the gesture-based control device. For example, method 200 may further include: detecting a second gesture performed by the user by the at least one sensor (130) of the gesture-based control device (100), the second gesture indicative of a second receiving device with which the user desires to interact (i.e., a second instance of act 201 whereby the user selects a different receiving device with which to interact, such as smartphone 321); identifying, by the processor (140), the second gesture performed by the user (i.e., a second instance of act 202); determining, by the processor (140), the second receiving device with which the user desires to interact (e.g., smartphone 321) based on the identified second gesture (i.e., a second instance of act 203); configuring, by the processor (140), a second signal for use exclusively by the second receiving device (i.e., a second instance of act 204); and wirelessly transmitting the second signal to the second receiving device by the wireless transmitter (i.e., a second instance of act 205). The processor (140) may execute processor-executable gesture identification instructions (151), stored in a non-transitory processor-readable storage medium (150), in order to identify the second gesture. The second gesture is distinct from the first gesture, and the non-transitory processor-readable storage medium (150) also includes processor-executable wireless connection instructions (152) that, when executed by the processor (140), cause the processor (140) to determine the particular receiving device with which the user desires to interact based on the identity of the second gesture performed by the user. An exemplary relationship between the gesture identification instructions (151) and the wireless connection instructions (152) is illustrated in FIG. 4.

FIG. 4 is an illustrative diagram of a non-transitory processor-readable storage medium (150) carried on-board a gesture-based control device (100; not illustrated in the Figure) and including both processor-executable gesture identification instructions (151) and processor-executable wireless connection instructions (152) in accordance with the present systems, devices, and methods. When executed by the processor (140) of the gesture-based control device (100), the gesture identification instructions (151) cause the processor (140) to effect a mapping between detection signals provided by the at least one sensor (130) of the gesture-based control device (i.e., from the column labeled “Sensor Signals” in FIG. 4) and gesture identities (i.e., from the column labeled “Gesture” in the gesture identification instructions of FIG. 4). Once the mapping is complete, the gesture identity that corresponds to the incoming sensor signals is passed to the wireless connection instructions (152). When executed by the processor (140) of the gesture-based control device (100), the wireless connection instructions (152) cause the processor (140) to effect a mapping between gesture identities (i.e., from the column labeled “Gesture” in the wireless connection instructions of FIG. 4) and receiving devices (i.e., from the column labeled “Receiving Device” in FIG. 4). As an example, the user may perform a first gesture that produces the sensor signals depicted in the second row in the gesture identification instructions of FIG. 4. The gesture identification instructions cause the processor to identify that the user has performed a “Thumbs Up” gesture based on these signals, as illustrated in FIG. 4. The fact that the user has performed a “Thumbs Up” gesture is then indicated to the wireless connection instructions, which cause the processor to determine that the user desires to interact with the Heads-Up Display based on the “Thumbs Up” gesture, as illustrated in FIG. 4.

In certain implementations of the present systems, devices and methods, a single receiving device may be used to route control signals from a gesture-based control device to multiple controllable devices through wired-connections. As an example, a wireless receiving device may be configured as a hub providing wired-connections to multiple controllable devices, and the present systems, devices, and methods may be used to select which controllable device among the multiple controllable devices the user wishes to control, with the selection being mediated by wireless communication between the gesture-based controller and the hub. Alternatively, in certain implementations aspects of the present systems, devices, and methods may be used to select a particular application with which a user wishes to interact among multiple available applications in a computing, virtual, or augmented environment. In this case, rather than establishing a wireless connection with a particular “receiving device,” the gesture-based control device may be used to establish wireless control of a particular application among multiple applications stored and/or run on/by a given receiving device.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the processor-readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to: U.S. Provisional Patent Application Ser. No. 61/954,379; U.S. Provisional Patent Application Ser. No. 61/857,105 (now US Patent Publication US 2015-0025355 A1); U.S. Provisional Patent Application Ser. No. 61/860,063 and U.S. Provisional Patent Application Ser. No. 61/822,740 (now combined in US Patent Publication US 2014-0334083 A1); U.S. Provisional Patent Application Ser. No. 61/940,048 (now U.S. Non-Provisional patent application Ser. No. 14/621,044); U.S. Provisional Patent Application Ser. No. 61/872,569 (now US Patent Publication US 2015-0065840 A1); U.S. Provisional Patent Application Ser. No. 61/866,960 (now US Patent Publication US 2015-0051470 A1); U.S. patent application Ser. No. 14/186,878 (now US Patent Publication US 2014-0240223 A1), U.S. patent application Ser. No. 14/186,889 (now US Patent Publication US 2014-0240103 A1), U.S. patent application Ser. No. 14/194,252 (now US Patent Publication US 2014-0249397 A1), U.S. Provisional Patent Application Ser. No. 61/869,526 (now US Patent Publication US 2015-0057770 A1), U.S. Provisional Patent Application Ser. No. 61/909,786 (now U.S. Non-Provisional patent application Ser. No. 14/553,657); U.S. Provisional Patent Application Ser. No. 61/881,064 (now U.S. Non-Provisional patent application Ser. No. 14/494,274); U.S. Provisional Patent Application Ser. No. 61/894,263 (now U.S. Non-Provisional patent application Ser. No. 14/520,081); and U.S. Provisional Patent Application Ser. No. 61/915,338 (now U.S. Non-Provisional patent application Ser. No. 14/567,826) are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a gesture-based control device to establish a wireless connection between the gesture-based control device and a particular receiving device, wherein the gesture-based control device includes a processor, at least one sensor communicatively coupled to the processor, and a wireless transmitter communicatively coupled to the processor, the method comprising:
detecting a first gesture performed by a user of the gesture-based control device by the at least one sensor, the first gesture indicative of a first receiving device with which the user desires to interact;
identifying, by the processor, the first gesture performed by the user;
determining, by the processor, the first receiving device with which the user desires to interact based on the identified first gesture;
configuring, by the processor, a first signal for use exclusively by the first receiving device; and
wirelessly transmitting the first signal to the first receiving device by the wireless transmitter.

2. The method of claim 1 wherein the at least one sensor includes at least one electromyography (“EMG”) sensor, and wherein detecting a first gesture performed by a user of the gesture-based control device by the at least one sensor includes detecting muscle activity of the user by the at least one EMG sensor in response to the user performing the first gesture.

3. The method of claim 1 wherein the at least one sensor includes at least one inertial sensor, and wherein detecting a first gesture performed by a user of the gesture-based control device by the at least one sensor includes detecting motion of the user by the at least one inertial sensor in response to the user performing the first gesture.

4. The method of claim 1 wherein the gesture-based control device further includes a non-transitory processor-readable storage medium communicatively coupled to the processor, wherein the non-transitory processor-readable storage medium stores processor-executable gesture identification instructions, and wherein identifying, by the processor, the first gesture performed by the user includes executing, by the processor, the gesture identification instructions to cause the processor to identify the first gesture performed by the user.

5. The method of claim 4 wherein the non-transitory processor-readable storage medium further stores processor-executable wireless connection instructions, and wherein:
determining, by the processor, the first receiving device with which the user desires to interact based on the identified first gesture includes executing, by the processor, the wireless connection instructions to cause the processor to determine the first receiving device with which the user desires to interact based on the identified first gesture; and
configuring, by the processor, a first signal for use exclusively by the first receiving device includes executing, by the processor, the wireless connection instructions to cause the processor to configure the first signal for use exclusively by the first receiving device.

6. The method of claim 1 wherein configuring, by the processor, a first signal for use exclusively by the first receiving device includes encrypting the first signal by the processor.

7. The method of claim 1 wherein configuring, by the processor, a first signal for use exclusively by the first receiving device includes programming, by the processor, the first signal with device identification data that is unique to the first receiving device.

8. The method of claim 1 wherein the gesture-based control device further includes a non-transitory processor-readable storage medium communicatively coupled to the processor, the method further comprising:
sequentially pairing the gesture-based control device with each receiving device in a set of receiving devices; and
storing, in the non-transitory processor-readable storage medium, respective pairing information corresponding to each respective receiving device in the set of receiving devices.

9. The method of claim 8, wherein:
determining, by the processor, the first receiving device with which the user desires to interact based on the identified first gesture includes determining, by the processor, which receiving device in the set of receiving devices corresponds to the first receiving device with which the user desires to interact based on the identified first gesture; and
configuring, by the processor, a first signal for use exclusively by the first receiving device includes configuring, by the processor, the first signal based on the pairing information corresponding to the first receiving device that is stored in the non-transitory processor-readable storage medium.

10. The method of claim 1, further comprising:
detecting a second gesture performed by a user of the gesture-based control device by the at least one sensor, the second gesture indicative of a second receiving device with which the user desires to interact;
identifying, by the processor, the second gesture performed by the user;
determining, by the processor, the second receiving device with which the user desires to interact based on the identified second gesture;
configuring, by the processor, a second signal for use exclusively by the second receiving device; and
wirelessly transmitting the second signal to the second receiving device by the wireless transmitter.

11. A gesture-based control device comprising:
at least one sensor responsive to gestures performed by a user of the gesture-based control device, wherein in response to gestures performed by the user the at least one sensor provides detection signals;
a processor communicatively coupled to the at least one sensor;
a non-transitory processor-readable storage medium communicatively coupled to the processor, wherein the non-transitory processor-readable storage medium stores:
processor-executable gesture identification instructions that, when executed by the processor, cause the processor to identify a first gesture performed by the user based on at least a first detection signal provided by the at least one sensor in response to the user performing the first gesture; and
processor-executable wireless connection instructions that, when executed by the processor, cause the processor to:
determine a first receiving device with which the user desires to interact based on the identified first gesture; and
configure a first communication signal for use exclusively by the first receiving device;
and
a wireless transmitter communicatively coupled to the processor to wirelessly transmit communication signals.

12. The gesture-based control device of claim 11 wherein the at least one sensor includes at least one sensor selected from the group consisting of: electromyography (“EMG”) sensor, an inertial sensor, a mechanomyography sensor, a bioacoustics sensor, a camera, an optical sensor, and an infrared light sensor.

13. The gesture-based control device of claim 11, further comprising:
a band that in use is worn on an arm of the user, wherein the at least one sensor, the processor, the non-transitory processor-readable storage medium, and the wireless transmitter are all carried by the band.

14. The gesture-based control device of claim 11 wherein:
the processor-executable gesture identification instructions, when executed by the processor, further cause the processor to identify a second gesture performed by the user based on at least a second detection signal provided by the at least one sensor in response to the user performing the second gesture; and
the processor-executable wireless connection instructions, when executed by the processor, further cause the processor to:
determine a second receiving device with which the user desires to interact based on the identified second gesture; and
configure a second communication signal for use exclusively by the second receiving device.

15. The gesture based control-device of claim 11 wherein the non-transitory processor-readable storage medium further includes a capacity to store respective pairing information corresponding to each respective receiving device in a set of receiving devices.
